(19) United States
(12) Patent Application Publication
(10) Pub. No.: US 2015/0315958 A1
(43) Pub. Date: Nov. 5, 2015

(54) Method for Operating A Turbocharged Internal Combustion Engine with Turbolag Compensation

(71) Applicants: Arie Jan HEKMAN, Spijk (NL); Marinus VAN DER PANNE, AN Benschop (NL)

(72) Inventors: Arie Jan HEKMAN, Spijk (NL); Marinus VAN DER PANNE, AN Benschop (NL)

(21) Appl. No.: 14/651,716

(22) PCT Filed: Dec. 16, 2013
(86) PCT No.: PCT/NL2013/050903

§ 371 Date: Jun. 12, 2015

(30) Foreign Application Priority Data
Dec. 14, 2012 (NL) 2009986

(51) Int. Cl. F02B 21/00; F02B 37/12; F02D 41/00; F02B 29/04

(52) U.S. Cl. CPC F02B 21/00; F02B 29/04; F02B 37/12; F02D 41/0007

(57) ABSTRACT

A method for operating a turbocharged internal combustion engine (1), comprises the steps of operating the engine (1) by feeding combustion air and/or fuel into one or more combustion chambers (3a-3f) via intake openings/inlet valves (4a-4f), combusting the air and fuel and having a flow of exhaust gases flow out via exhaust openings/outlet valves (11a-11f), with the flow of exhaust gases driving a turbine portion (20a) which in turn drives a compressor portion (20b) for compressing combustion air prior to being fed into the one or more combustion chambers (3a-3f). The secondary air injection means (25-27) are activated for injecting pressurized secondary air into the engine (1) during an accelerating operation of the engine (1), in such a way that during said accelerating operation of the engine (1), one or more loads of pressurized secondary air are injected into the outlet manifold (12).

The invention relates to a method for operating a turbocharged internal combustion engine.

From the state of the art a wide variety of turbocharged internal combustion engines are known. For example GB 2 121 474 shows a vehicle with a two-stage turbocharged internal combustion engine. The engine comprises an engine block with a combustion air inlet duct and an exhaust gas outlet duct. Two turbochargers are provided each having a turbine portion and a compressor portion. The turbine portions are positioned inside the outlet duct, and the compressor portions are positioned inside the inlet duct. During operation of the engine combustion air and/or fuel are fed into one or more combustion chambers of the engine block and combusted there. A flow of exhaust gases then flows out via the outlet duct. The flow of exhaust gases drives the turbine portion which in turn drives the compressor portion. The compressor portion compresses combustion air sucked into the inlet duct out of the environment. Subsequently this compressed combustion air is being fed into the chamber(s) of the engine block. In order to improve the response of the turbochargers during low engine speeds, compressed so-called secondary air is fed from a tank into the outlet duct close to the first turbine portion in response to predetermined accelerator pedal depression by a driver of the vehicle. The tank is charged by a separate engine-driven compressor or by one of the compressors of the turbochargers.

A disadvantage of this is that the response of the turbochargers still leaves to be desired. The flow of secondary air merely serves to directly boost the first turbine portion. This requires large amounts of secondary air. Furthermore the injection of secondary air keeps on taking place for as long as the accelerator pedal is depressed by the user to the predetermined amount. This also requires large amounts of secondary air. Because of this a very large tank for storage of the secondary air is necessary, particularly since the tank can only be charged by means of either the engine-driven compressor either the turbocharger compressor, both of which are unable to quickly recharge the tank for as long as the engine and/or turbocharger speeds are still low.

FR 2 831 609 shows a similar type of turbocharged internal combustion engine in which secondary air can be injected straight at a turbine wheel of a turbocharger in order to directly boost it to higher rotational speeds. Again this however requires large amounts of secondary air, whereas the response of the turbocharger leaves to be desired.

FR 2 875 267, DE 37 37 743, US 2007/0283939, WO 2006/128974 and DE 10 2004 037 763 show turbocharged internal combustion engines in which secondary air can be injected into an inlet manifold of the engine block. Due to the introduction of additional air the amount of combustion air fed into the combustion chamber increases while an engine control system increases the amount of fuel fed into the combustion chambers when the load of the engine changes. As a result hereof larger fuel mixtures get combusted and the exhaust gas flows increase, because of which the rotation speed of the turbo compressor and thereby the pressure of the combustion air at the location of the compressor portion of the turbocharger increases. Another aim of this secondary air injection at the inlet side may be to get the inlet pressure of the combustion chamber to be higher than the outlet pressure thereof such that a flowing of exhaust gases back into the inlet duct is prevented.

This secondary air injection at the inlet side still requires relative high amounts of secondary air, together with an increase of fuel consumption, whereas the response of the turbocharger to this secondary air injection always runs a step behind.

The present invention aims to at least partly overcome one or more of the abovementioned disadvantages and/or to provide a usable alternative. In particular the invention aims to provide an environmentally-friendly method for operating a turbocharged internal combustion engine with which a vehicle can be driven more cost-efficient and with higher comfort.

This aim is achieved by means of a method according to claim 1. The method comprises the step of operating an internal combustion engine by feeding combustion air and/or fuel via intake openings/inlet valves into one or more combustion chambers of an engine block thereof. An internal combustion then takes place and a flow of exhaust gases flows out via exhaust openings/outlet valves of the chambers. With this the flow of exhaust gases drives a turbine portion of a turbocharger which in turn drives a compressor portion of this same turbocharger. An inlet manifold connects the intake openings/inlet valves of the combustion chambers to a central combustion air inlet duct, inside which the compressor portion is provided. An outlet manifold connects the exhaust openings/outlet valves of the combustion chambers to a central exhaust gas outlet duct, inside which the turbine portion is provided. The compressor portion compresses the combustion air prior to it being fed into the one or more combustion chambers. Secondary air injection means are activated for injecting pressurized secondary air into the engine during accelerating operations of the engine. According to the inventive thought one or more loads of the pressurized secondary air are injected into the outlet manifold of the engine, that is to say at a distance of the turbine portion in the central exhaust gas outlet duct. With this the secondary air is being injected into the outlet manifold at a temperature which is lower than the temperature of the exhaust gases flowing through this outlet manifold. Furthermore the secondary air is being injected into the outlet manifold at a pressure which is higher than the pressure of the exhaust gases flowing through this outlet manifold. Those measures together have the effect that the injected secondary air expands inside the exhaust gases while flowing through the outlet manifold and before reaching the turbine portion. The injection of secondary air takes place when the secondary air injection means are activated, that is to say in particular only during said accelerating operations of the engine.

Thus according to the inventive thought, the one or more loads of pressurized secondary air are injected into the outlet manifold at said lower temperature and said higher pressure, during said accelerating operation of the engine. The relative cool and pressurized secondary air then enters the outlet manifold at a temperature which is at least lower than the temperature of the exhaust gases flowing through this outlet manifold. In particular the secondary air is being injected at a temperature which is less than half the temperature of the exhaust gases in the outlet manifold. More in particular the secondary air is being injected at a temperature which is less than 100 degrees Celsius, preferably it may lie between −20 to +100 degrees Celsius. Depending on the type of engine and the type of fuel the temperature of the exhaust gases can for example be 700 degrees Celsius or more, whereas the temperature of the secondary air can for example be kept between environmental temperature and 100 degrees Celsius. A temperature difference of several hundreds of degrees Celsius. Furthermore, the pressurized secondary air enters the outlet manifold at a pressure which is at least higher than the pressure of the exhaust gases flowing through this outlet manifold. In particular the secondary air is being injected at a pressure which is at least twice the pressure of the exhaust gases in the outlet manifold. More in particular the secondary air is being injected at a pressure which is more than 2 bar, preferably it may lie between 2-200 bar. Depending on the type of engine and the type of fuel this pressure of the exhaust gases can for example be between 1-2 bar, whereas the pressure of the secondary air can for example be kept at least higher than 4 bar, for example between 8-10 bar. The effect of this is that immediately after a load of the relative low temperature and relative high pressurized secondary air has been injected into the outlet manifold, the volume of this load of secondary air shall expand enormously (hereafter called flash expansion). This immediately multiplies the total air/gas-flow towards the turbine portion, which causes the rpm of the turbocharger to rise considerably faster. Another effect of the injection with secondary air inside the outlet manifold can be that it may help to effect secondary combustion of fuel rests which have not combusted inside the combustion chamber itself yet. This not only reduces smut and other undesired emission, it helps to increase the flowing speed of the air/gas-flow towards the turbine portion, and thus to more rapidly speed up the rpm of the turbocharger.

The combination of features according to the invention has appeared to make a great number of advantages possible. As most important economic advantage a lower fuel consumption has appeared possible compared to already known systems. A vehicle equipped with an engine using this inventive method can be brought quicker at aimed higher speed levels. When this vehicle is forced to quickly accelerate and/or perform a gearshift, a substantial lower emission of NOx and black smut can be obtained. For example for truck engines the invention makes it possible to fulfil the each year more increasing standards of less NOx and smut to which the exhaust gases need to come up to. During driving of the vehicle, a driver can immediately notice that the engine is able to more easily pick up the desired speed increase at lower rpm. The driver does not have to shift the gear as often anymore. He even can skip some gears. Particularly when driving in the mountains, a vehicle can now achieve improved climbing capacities. All in all the driving comfort can be considerably improved. If for example an engine of which the gear has been shifted, falls back to 900 rpm it is now easily possible to immediately deliver 1.0 bar or more turbo pressure.

Particularly extraordinary and unique about the present invention is that it is now for the first time possible to obtain, after for example each gear shift, a turbo pressure which is at least 50% higher than already known systems.

Because of the used injection technique of secondary air according to the invention a chain reaction advantageously takes place. Because of the flash expansion in the outlet manifold, the gas flow and the turbo pressure are directly hugely increased. This results immediately in a higher intake air pressure at the inlet manifold. This causes a signal to be sent out to the fuel injection system to inject more fuel. This results in higher exhaust gas flows, which helps to further increase the turbo pressure, etc. Thus at lower rotational speeds, turbo pressures can already be obtained which normally cannot be realized. Because of the overflow of intake air and exhaust gases, less exhaust of smut shall take place. In contrast to conventional systems it is not necessary to first inject more fuel to obtain a higher turbo pressure. This step is first skipped according to the invention, and only takes place after the system has already received a signal that the turbo pressure has increased. This also leads to less environmental pollution.

In a preferred embodiment the one or more loads of pressurized secondary air are injected into the outlet manifold only during an initial phase of said accelerating operation of the engine and/or only if an engine operating command has been given for feeding substantially full loads of combustion air and/or fuel to the one or more combustion chambers in order to obtain an aimed engine acceleration and/or only if an engine operating command has been given for a gearshift preceding said accelerating operation of the engine. Owing to the invention it is no longer necessary to inject pressurized secondary air during an entire acceleration operation and/or during each acceleration operation. This makes it advantageously possible to efficiently use the secondary air injection system and in particular use limited amounts of pressurized secondary air in order to be able to overcome the turbolag. For example a secondary air pressure vessel of less than 50 litres may suffice for storing 50 litres of pressurized secondary air therein. Such a secondary air pressure vessel can then even be combined with a pressurized air installation for a braking system or other pneumatic means of the vehicle. Providing two separate vessels having an overflow valve in between them is also possible. Owing to the small amounts of the loads of pressurized air which need to be injected only during the described situations and/or phases, a pressure drop inside such a vessel or combination of vessels can easily be kept at less than 1 bar, and for example be approximately 0.5 bar. Thus critical operations like a braking of the vehicle do not get endangered.

In order to further minimize the total injection of pressurized secondary air, the one or more loads of pressurized secondary air can be injected into the outlet manifold only for a time period of between 1-600 seconds during an accelerating operation of the engine. In a particular embodiment each injection of the one or more loads of pressurized secondary air into the respective manifold(s) is set to last less than 5 seconds, in particular less than 2 seconds, more in particular less than 0.5 seconds. Thus merely short impact loads of pressurized secondary air are injected which have appeared to already have a large enough positive effect on boosting the turbine portion of the turbocharger at low engine speeds. With this it is noted that the injection of merely short impact loads of pressurized secondary air which impact loads last shorter than a few seconds has the advantage that the positive effect of the flash expansion is kept maximised. Should the injection for example be continuous then the temperature of the mixture of the exhaust gases and injected secondary air would drop too much for a sufficient flash expansion to be able to take place. A large part of the positive effect would then get lost.

If the engine comprises an engine block with more than one combustion chamber, then the outlet manifold connects to a plurality of exhaust openings/outlet valves. The secondary air injection then can take place at only one or two locations of the outlet manifold. In a variant for each of the respective exhaust openings/outlet valves, individually operable secondary air injection nozzles may be provided. Thus the pressurized secondary air can be injected into the outlet manifold at the location of each exhaust opening/outlet valve. It is then even possible to inject the one or more loads of pressurized secondary air into the outlet manifold only during opening of outlet valves of those respective exhaust openings. An individual and exact tuning of the secondary air injection with the opening and closing of the exhaust openings is then possible.

In another embodiment the one or more loads of pressurized secondary air are injected into the outlet manifold at the side of their connections with the exhaust openings/outlet valves.

In the case of injection into the outlet manifold the secondary air preferably gets injected as close as possible to a point inside the outlet manifold where the temperature of the exhaust gases is high and thus the flash expansion of the injected load of secondary air can be high, while at the same time the distance to the turbine portion is large enough to give space for this flash expansion. In particular a maximum distance of 25 centimetres, more in particular a maximum distance of 10 centimetres, is present between the exhaust opening(s)/outlet valve(s) and the secondary air injection means, and/or a minimum distance of 10 centimetres, more in particular a minimum distance of 25 centimetres, is present between the outlet duct (where the turbine portion is located) and the secondary air injection means.

Further advantageous embodiments are stated in the dependent subclaims. The invention also relates to an internal combustion engine with a turbocharging system and to an assembly of a vehicle with such an internal combustion engine with a turbocharging system.

The invention shall now be explained in more detail with reference to the accompanying drawing, in which:

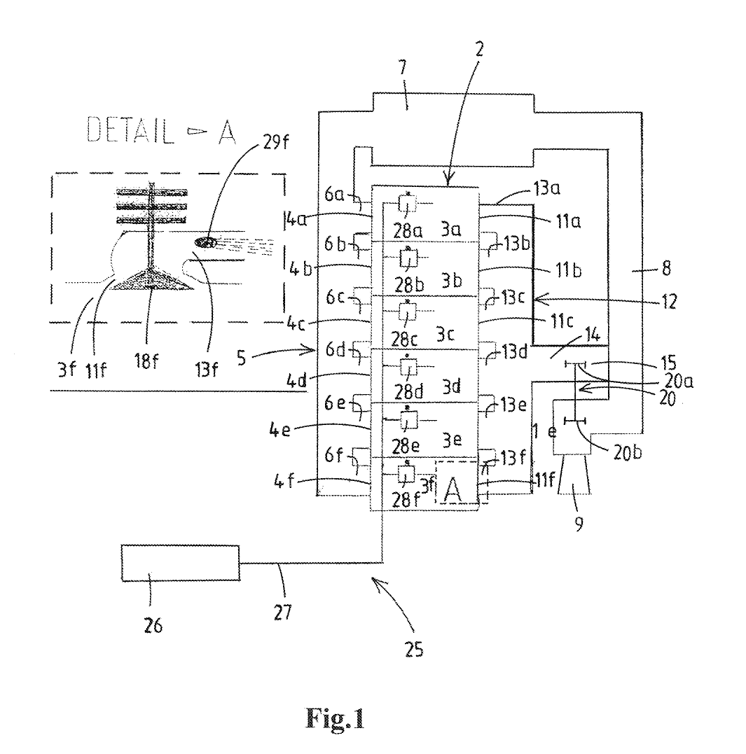

FIG. 1 shows a schematic view of an embodiment of an engine according to the invention with plural injection of secondary air at the location of each exhaust opening/outlet valve in an outlet manifold; and

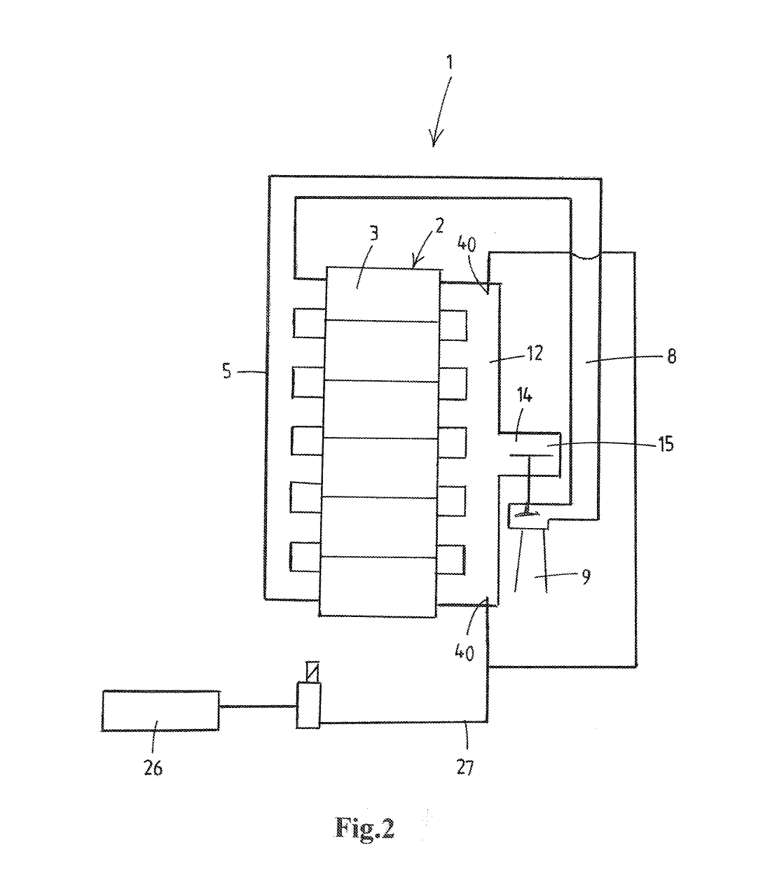

FIG. 2 shows a schematic view of an embodiment of an engine according to the invention with sideways injection of secondary air into an outlet manifold.

The entire engine has been given the reference numeral 1 in FIG. 1. The engine 1 comprises an engine block 2 with six combustion chambers 3a-f.

Each chamber 3a-f has its own intake opening/inlet valve 4a-f. An inlet manifold 5 is connected with a complementary number of its branches 6a-f to the plurality of intake openings/inlet valves 4a-f. Upstream, the inlet manifold 5 connects to an intercooler 7 from where it connects to a central combustion air inlet duct 8. The central combustion air inlet duct 8 at its free outer end is provided with an inlet opening 9 via which fresh air from out of the environment can enter.

Each chamber 3a-f further has its own exhaust opening/outlet valve 11a-f. An outlet manifold 12 is connected with a complementary number of branches 13a-f to the plurality of exhaust openings/outlet valves 11a-f. Downstream, the outlet manifold 12 connects to a central exhaust gas outlet duct 14. The central exhaust gas outlet duct 8 at its free outer end is provided with an outlet opening 15 via which combusted exhaust gases can flow into the environment.

The engine 1 which in the shown embodiment is merely schematically shown, is a piston-cylinder operated diesel engine. During operation fresh air is periodically allowed, by means of operation of respective intake valves (not shown) to be fed into each respective combustion chamber 3a-f. There it is mixed with diesel fuel which is injected into each chamber 3a-f separately via a respective fuel injection nozzle (not shown). The diesel and air are subsequently combusted inside their respective chambers 3a-f. Respective exhaust valves 18a-f are then operated for the respective chambers 3a-f to open their respective exhaust opening 11a-f such that exhaust gases which are formed during the combustion process can flow out of the respective chambers 3a-f via the respective branches 13a-f into the outlet manifold 12 and from there through the central exhaust gas outlet duct 14 towards the outlet opening 15.

A turbocharger 20 is provided which has a turbine portion 20a, in particular a turbine wheel, inside the central exhaust gas outlet duct 14, and which has a compressor portion 20b, in particular a compressor wheel, inside the central combustion air inlet duct 8. The turbine portion 20a is connected in such a way, for example by being mounted on a common axis, to the compressor portion 20b that when the turbine portion 20a is driven it automatically drives the compressor portion 20b. During operation of the engine 1, the exhaust gases flow towards the outlet opening 15 and drive the turbine portion 20a in rotation. This causes the compressor portion 20b to co-rotate. This rotation of the compressor portion 20b compresses the combustion air towards the intakes 4a-f of the chambers 3a-f, and thus turbocharges the engine 1.

According to the invention secondary air injection means 25 are provided which comprises a vessel 26 which is filled with air which has been pressurized to a pressure of about 8-10 bar and which is held at substantially environmental temperature. The vessel 26 connects to a secondary air duct 27 which via operable injection valves 28a-f lead to secondary air injection nozzles 29a-f. For each chamber 3a-f an individually operable injection valve 28a-f and a dedicated injection nozzle 29a-f is provided.

Control means are provided for detecting an engine operating signal and opening and closing the operable injection valves 28a-f in dependence thereof. The control means are programmed to only during an initial start-up phase of a “heavy load” accelerating operation of the engine, open the injection valves 28a-f for having one or more loads of pressurized secondary air flow out of the vessel 26 into the respective branches 13a-f of the outlet manifold 12. With this the nozzles 29a-f are directed substantially parallel to the flowing direction of the exhaust gases towards the turbine portion 20a. The injection of secondary air, during this engine acceleration can take place only during opening of the exhaust valves 18a-f or be continuous.

The fact whether or not such a “heavy load” accelerating operation is going to take place or takes place which necessitates activation of the secondary air injection means during the initial start-up phase thereof, can be distinguished by detecting certain engine conditions and/or control operations given to the engine. If the invention for example is used inside a truck, then the secondary air injection means can be activated if the driver substantially fully presses the gas pedal/throttle in order to have the truck accelerate and/or drive up a steep road. This can then for example be combined with detecting whether the speed of the truck is at least 20 km/h, and/or the truck is at least in third gear, and/or the truck is loaded to at least 25% of its maximum loading capacity. In the alternative it is also possible to provide a simple on/off switch for the driver so that he himself can decide when to activate the secondary air injection means. All in all typical situations can be defined/prescribed in which the injection of secondary air into the outlet manifold 12 is deemed advantageous, because in those situations the turbocharger 20 is still at a relative low speed and thus is unable to sufficiently compress the combustion air in line with the increased demand for combustion air by the engine 1 because of the extra gas given by the driver. The injection of the secondary air into the outlet manifold 12 then causes the turbocharger 20 to more quickly build up turbo pressure because of increased flow, flash expansion and/or secondary combustion. Thus the rpm of the turbocharger can quickly rise to an aimed higher speed corresponding to an amount of extra effort being demanded of the engine. As soon as this higher speed is reached and/or the extra effort is no longer demanded of the engine, the secondary air injection means can automatically or manually be switched off again. At least the means are automatically switched off again after a set period of 1-600 seconds. Moreover each distinctive injection of one of the loads of secondary air injection is preferably set to last less than 2 seconds, for example approximately 0.5 seconds. This is long enough for a flash expansion to take place whereas it lowers the pressure inside the vessel 26 with no more than 0.5 bar.

In FIG. 1 the injection of the secondary air takes place at each individual branch of the outlet manifold. It is also possible to have it take place in other parts of the outlet manifold. FIG. 2 shows as an example that two secondary air injection nozzles 40 are positioned at two opposite outer ends of the outlet manifold 12. Individually operable injection valves then are no longer necessary and the nozzles can be steered to continuously inject secondary air during said initial start-up phase of “heavy load” acceleration.

Besides the embodiments shown numerous variants are possible. For example the invention can also be used for other types of fuel engines, like gas or petrol internal combustion engines. Also different types and numbers of combustion chambers can be provided.

Thus the invention provides an improved turbocharger functionality for IC engines with which less pollution of the environment can take place during accelerations of the engine, in particular during load shifts, by being capable to more quickly fulfil a demand for extra air.

1. A method for operating a turbocharged internal combustion engine, the method comprising the steps of:
providing an internal combustion engine having:
an engine block with one or more combustion chambers, each chamber having an intake opening and inlet valve and an exhaust opening and outlet valve;
an inlet manifold connecting a central combustion air inlet duct to the intake openings and inlet valves;
an outlet manifold connecting the exhaust openings and outlet valves to a central exhaust gas outlet duct;
a turbocharger having a turbine portion and a compressor portion, the turbine portion being positioned inside the central exhaust gas outlet duct, and the compressor portion being positioned inside the central combustion air inlet duct; and
a secondary air injection system for injecting pressurized secondary air into the engine,
operating the engine by feeding combustion air and/or fuel into the one or more combustion chambers via their intake openings and inlet valves, combusting the air and fuel and having a flow of exhaust gases flow out via the exhaust openings and outlet valves, with the flow of exhaust gases driving the turbine portion which in turn drives the compressor portion for compressing combustion air prior to being fed into the one or more combustion chambers;
activating the secondary air injection system for injecting pressurized secondary air into the engine during an accelerating operation of the engine, and wherein during said accelerating operation of the engine one or more loads of pressurized secondary air are injected into the outlet manifold, with the secondary air being injected at a temperature which is lower than the temperature of the exhaust gases in the outlet manifold, and with the secondary air being injected at a pressure which is higher than the pressure of the exhaust gases in the outlet manifold, such that the injected secondary air expands before reaching the turbine portion.

2. The method according to claim 1, wherein the secondary air is injected at a temperature which is less than half the temperature of the exhaust gases in the outlet manifold.

3. The method according to claim 2, wherein the secondary air is injected at a temperature between −20 to +100 degrees Celsius.

4. The method according to claim 1, wherein the secondary air is injected at a pressure which is at least twice the pressure of the exhaust gases in the outlet manifold.

5. The method according to claim 4, wherein the secondary air is injected at a pressure between 2-200 bar.

6. The method according to claim 1, wherein the one or more loads of pressurized secondary air are injected into the outlet manifold only during an initial phase of said accelerating operation of the engine.

7. The method according to claim 1, wherein the one or more loads of pressurized secondary air are injected into the outlet manifold only if, during said accelerating operation of the engine, an engine operating command has been given for feeding substantially full loads of combustion air and/or fuel to the one or more combustion chambers.

8. The method according to claim 1, wherein the one or more loads of pressurized secondary air are injected into the outlet manifold only if an engine operating command has been given for a gearshift preceding said accelerating operation of the engine.

9. The method according to claim 1, wherein the one or more loads of pressurized secondary air are injected into the outlet manifold only for a time period of between 1-600 seconds during said accelerating operation of the engine.

10. The method according to claim 1, wherein each injection of the one or more loads of pressurized secondary air into the outlet manifold lasts less than 5 seconds.

11. The method according to claim 1, wherein the engine block comprises more than one combustion chamber, and the pressurized secondary air is injected into the outlet manifold at the location of each exhaust opening and outlet valve.

12. The method according to claim 1, wherein the one or more loads of pressurized secondary air are injected into the outlet manifold only during opening of outlet valves of respective exhaust openings.

13. The method according to claim 1, wherein the one or more loads of pressurized secondary air are injected into the outlet manifold a maximum of 25 centimetres from the exhaust openings and outlet valves.

14. The method according to one claim 1, wherein the one or more loads of pressurized secondary air are injected into the outlet manifold at a minimum distance of 10 centimetres from the outlet duct.

15. An internal combustion engine with a turbocharging system, the internal combustion engine comprising:
an engine block having one or more combustion chambers, each chamber having an intake opening and inlet valve for combustion air to flow into the chamber and an exhaust opening and outlet valve for exhaust gases to flow out of the chamber;
an inlet manifold connecting a central combustion air inlet duct to the one or more intake openings and inlet valves;
an outlet manifold connecting the one or more exhaust openings and outlet valves to a central exhaust gas outlet duct;
a turbocharger having a turbine portion and a compressor portion, the turbine portion being positioned inside the central exhaust gas outlet duct, and the compressor portion being positioned inside the central combustion air inlet duct;
a secondary air injection system having a secondary air pressure vessel designed to store a load of pressurized air and which connects to a secondary air duct which, via one or more operable valves, leads to one or more secondary air injection nozzles, and wherein the secondary air injection system opens out into the outlet manifold; and
control means for detecting an engine operating signal and opening and closing the operable valve in dependence of said detected engine operating signal.

16. The internal combustion engine according to claim 15, wherein the secondary air injection system opens out into the outlet manifold substantially in the direction of the outlet duct towards the turbine portion.

17. The internal combustion engine according to claim 15, wherein the control means are designed for, when the engine operating signal is detected, temporarily opening the operable valve for injection of the one or more loads of pressurized secondary air into the outlet manifold for a period of between 1-600 seconds.

18. A vehicle comprising the internal combustion engine of claim 15.

19. The vehicle of claim 18, wherein the secondary air pressure vessel is combined with a pressurized air installation for a braking system of the vehicle.
